(19) United States
(12) Patent Application Publication
(10) Pub. No.: US 2025/0285644 A1
(43) Pub. Date: Sep. 11, 2025

(54) OPTIMAL FAST-FORWARDING WHILE PRESERVING STORYLINE

(71) Applicant: TiVo Platform Technologies LLC, San Jose, CA (US)

(72) Inventors: Govind RAVEENDRANATHAN NAIR, Bangalore (IN); Sangeeta PARIDA, Bangalore (IN); Johnson JOSEPHRAJ, Bangalore (IN); Rohit BUDHIRAJA, Ghaziabad (IN); Vasanth Raj RAJANNA, Bangalore (IN)

(21) Appl. No.: 19/075,629

(22) Filed: Mar. 10, 2025

Related U.S. Application Data
(60) Provisional application No. 63/563,756, filed on Mar. 11, 2024.

(51) Int. Cl. G11B 27/00; H04N 21/431; H04N 21/44; H04N 21/472; H04N 21/8549

(52) U.S. Cl. CPC G11B 27/005; H04N 21/4316; H04N 21/44008; H04N 21/47217; H04N 21/8549

(57) ABSTRACT

Generally disclosed herein is a mechanism to analyze the segments of media content when a viewer engages in fast-forwarding and automatically disengages the fast-forwarding when the progression of the media content reaches the segment that contains essential scenes. The segment containing the essential scenes may be played at a normal speed, and once the playback of the segment containing the essential scenes is completed, the fast-forwarding may be re-engaged. The essential scenes may include scenes such as scenes having an impact on the storyline of the media content. Alternatively, a summary of the skipped segments may be generated and presented to the viewer without disengaging the fast-forwarding of the scenes containing the essential scenes.

### CROSS-REFERENCE TO RELATED APPLICATIONS

The present application claims the benefit of the filing date of U.S. Provisional Patent Application No. 63/563,756, filed on Mar. 11, 2024, the disclose of which is hereby incorporated by reference.

### BACKGROUND

Media content may contain scenes that are not interesting or appealing to a viewer. In such a case, the viewer may attempt to fast-forward through the media content to find the next interesting or appealing scenes. However, the skipped scenes may often contain actions or dialogues central to understanding the context or storyline of the media content as a whole. The viewer may have to rewind the media content to rewatch the skipped actions or dialogues to understand the storyline. This may lead the viewer to frequently fast-forward and rewind the media content, which may significantly degrade the viewing experience.

### BRIEF SUMMARY

Generally disclosed herein is a mechanism to analyze the segments of media content when a viewer engages in fast-forwarding and automatically disengages the fast-forwarding when the progression of the media content reaches the segment that contains essential scenes. In some examples, the segment containing the essential scenes may be played at a normal speed, and once the playback of the segment containing the essential scenes is completed, the fast-forwarding may be re-engaged. In other examples, a summary of the essential scenes may be generated and presented to the viewer without disengaging the fast-forwarding segment. The essential scenes may include, for example, scenes having an impact on the storyline of the media content.

An aspect of the disclosure provides a method for fast-forwarding while preserving a storyline, the method comprising: parsing a media content; identifying one or more segments of the media content; determining a relevance value of each of the one or more segments; receiving a command to fast-forward through the media content; in response to receiving the command to fast-forward through the media content, fast-forwarding until reaching a first segment of the one or more segments with the relevance value exceeding a pre-configured threshold value; and in response to reaching the first segment, taking at least one of a first action or a second action.

Another aspect of the disclosure provides a system for fast-forwarding while preserving a storyline, the system comprising: memory; and one or more processors configured to: parse a media content; identify one or more segments of the media content; determine a relevance value of each of the one or more segments; receive a command to fast-forward through the media content; in response to receiving the command to fast-forward through the media content, fast-forward until reaching a first segment of the one or more segments with the relevance value exceeding a pre-configured threshold value; and in response to reaching the first segment, take at least one of a first action or a second action.

Yet another aspect of the disclosure provides a non-transitory computer-readable medium storing instructions executable by one or more processors to perform a method for fast-forwarding while preserving a storyline, the method comprising: parsing a media content; identifying one or more segments of the media content; determining a relevance value of each of the one or more segments; receiving a command to fast-forward through the media content; in response to receiving the command to fast-forward through the media content, fast-forwarding until reaching a first segment of the one or more segments with the relevance value exceeding a pre-configured threshold value; and in response to reaching the first segment, taking at least one of a first action or a second action.

The above and other aspects of the disclosure can include one or more of the following features. In some examples, aspects of the disclosure provide for all of the following features in combination.

In an example, the first action comprises disengaging the fast-forwarding.

In another example, the method further comprises reengaging the fast-forwarding until reaching a second segment of the one or more segments with the relevance value exceeding the pre-configured threshold value.

In yet another example, the method further comprises providing an option to the user to override the disengaging the fast-forwarding.

In yet another example, the second action comprises generating a first summary of the first segment.

In yet another example, the method further comprises displaying the first summary on an overlay display while fast-forwarding.

In yet another example, the relevance value is determined based on at least one of a historical number of replays, a number of clips generated from each of the one or more segments by previous users, or a number of likes provided by the previous users.

In yet another example, the relevance value is determined based on texts appearing in each segment of the media content.

In yet another example, the method further comprises generating a graph representing one or more spikes indicating most viewed or replayed segments.

In yet another example, the method further comprises determining the pre-configured threshold value based on an amplitude of a smallest spike from the one or more spikes, an average of the amplitude of the smallest and a largest spikes of the one or more spikes or an average of amplitudes of all of the one or more spikes.

In yet another example, the pre-configured threshold is adjustable based on user's preference data.

In yet another example, the user preference data includes the user's viewing habits, content preferences and time spent on preferred media contents.

### BRIEF DESCRIPTION OF THE DRAWINGS

FIG. 1A-B depict diagrams illustrating user-initiated fast-forwarding of media content and automatic disengagement of the fast-forwarding according to aspects of the disclosure.

FIG. 2 depicts a block diagram illustrating the generating and displaying of a summary of the fast-forwarded segment containing essential scenes according to aspects of the disclosure.

FIG. 3 depicts a block diagram illustrating an example media fast-forwarding system according to aspects of the disclosure.

FIG. 4 depicts a graph with one or more spikes indicating magnitudes of relevancy values according to aspects of the disclosure.

FIG. 5 depicts a graph illustrating amplitudes of one or more spikes to determine a threshold value according to aspects of the disclosure.

FIG. 6 depicts a graph illustrating a threshold value determined based on the differentials obtained from the changes in relevance values according to aspects of the disclosure.

FIG. 7 depicts a graph illustrating an adjustable interval of the relevant segment based on a user's preference according to aspects of the disclosure.

FIG. 8 depicts a block diagram illustrating example components of a media fast-forwarding system according to aspects of the disclosure.

FIG. 9 depicts a block diagram illustrating an example media system according to aspects of the disclosure.

FIG. 10 depicts a flow diagram illustrating an example media fast-forwarding process according to aspects of the disclosure.

FIG. 11 depicts a flow diagram illustrating an example media fast-forwarding and summary generation process according to aspects of the disclosure.

### DETAILED DESCRIPTION

The present disclosure provides a system and method for automatically disengaging user-initiated fast-forwarding of media content when the progression of the media content being fast-forwarded reaches a segment that contains essential scenes central to understanding the story or plot of the media content. The relevant segment may be played at a normal speed. When the playback time of the relevant segment is over, the fast-forwarding may automatically be re-engaged. Alternatively, relevant segments can be skipped even if the segments contain essential scenes. When the relevant segments are reached, summaries of the segments can be generated for display on a user device without disengaging the fast-forwarding. The viewer may be given the option to override the engagement and/or disengagement of the fast-forwarding or the display of the text summary.

A plurality of parameters may be considered to assess each of the plurality of segments of the media content. The parameters may include, for example, the number of views and/or replays, the number of excerpts downloaded from a segment, the number of “likes” provided by viewers, sudden changes in emotions or actions or appearances of new characters, and certain graphic or text information displayed within each segment. The above parameters may be used to generate a line graph with a y axis indicating a combination of the number of views, replays, or changes in camera angles, background, music, etc., and an x-axis depicting the playback time of the media content in seconds and/or minutes. The generated line graph may contain one or more peaks. The peaks may represent high points in the graph where the data counts of the above parameters are higher than other areas of the graph. The peaks may be compared with a threshold. Any portion of the graph that falls under the threshold may represent irrelevant or skippable segments. A threshold may be computed based on the amplitudes of the one or more peaks. A machine learning model trained with data collected by a media application for other similar types of media content can be used to update the number and amplitudes of the peaks and eventually can adjust or change the threshold. The statistics such as mean, average, or mode may be obtained from the amplitudes of the peaks and used to continuously update the threshold.

In some examples, the threshold may be determined based on the amplitudes of various peaks in the graph. For example, the peak with the smallest amplitude in a graph may be considered as a threshold. An average of the smallest and largest amplitudes of the peaks can also be considered a threshold. According to some examples, an average of all the amplitudes of all peaks can be considered a threshold. In other examples, a median value of the amplitudes of all peaks can be considered a threshold. Differentials of the peaks may also be used to calculate a threshold. Differentials may refer to a mathematical operation that calculates the rate of change of a function (i.e. the line graph) with respect to a variable.

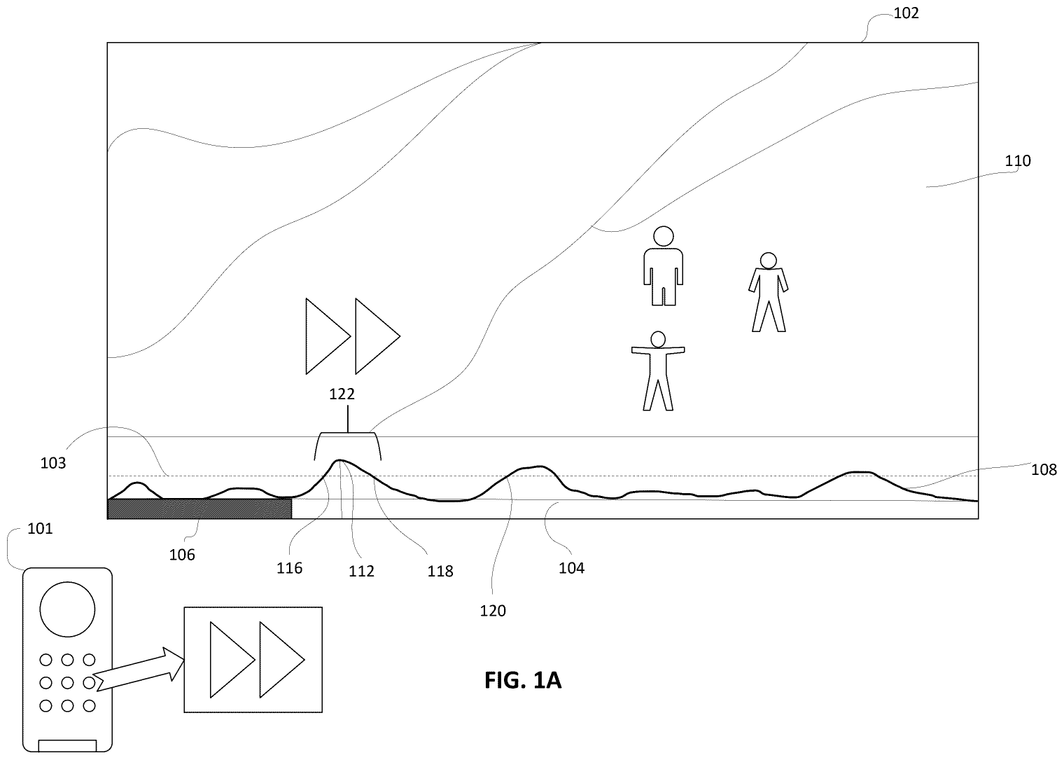

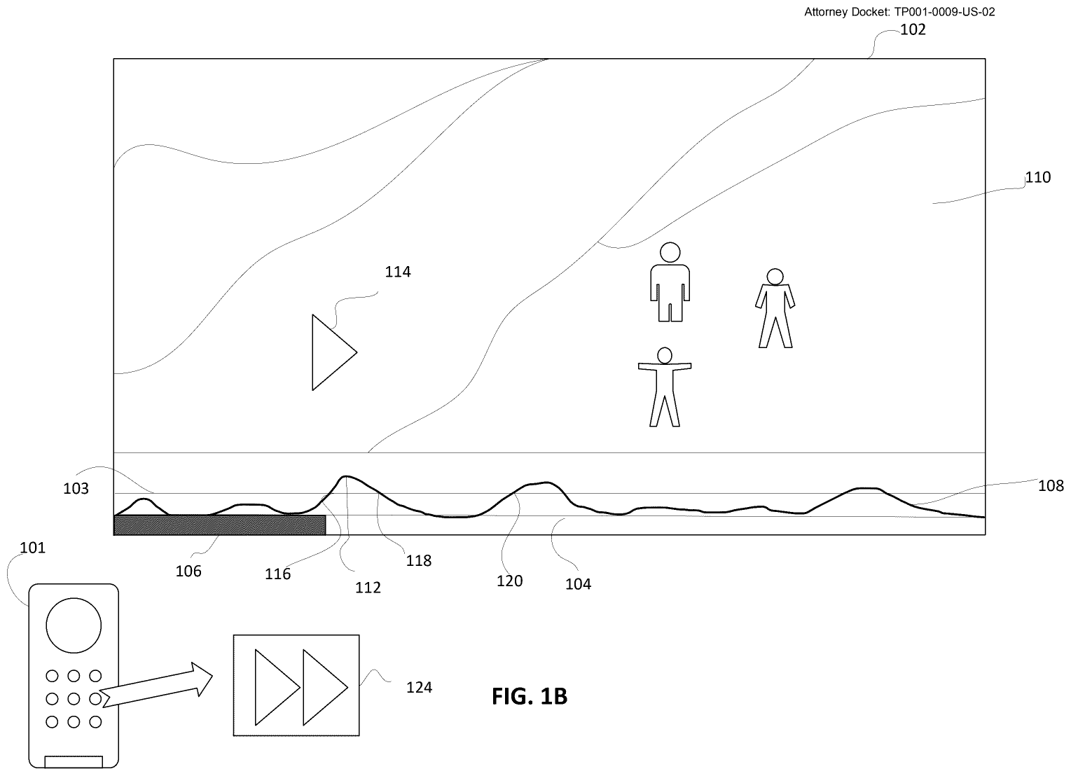

FIG. 1A depicts a block diagram illustrating media content being fast-forwarded. In this example, a viewer is viewing scene 110 of media content on a display screen 102. In scene 110, three characters are interacting and dialoguing with one another. The viewer may use remote controller 101 communicable with display screen 102 to fast-forward the media content. The viewer may start fast-forwarding the media content when particular scenes are not appealing to the viewer, or when the viewer wants to find more exciting scenes containing significant actions or interactions between major characters. Progress bar 106 may indicate the progression of the playback of the media content in real time. Graph 108 may represent a line chart drawn based on parameters, such as the number of views, replays, positive reactions, etc. associated with each portion of the media content. Graph 108 may contain one or more peaks. For example, peak 112 may represent the point of the playback time or scene where the greatest number of viewers replayed, viewed, or provided positive reactions to the media content. Graph 108 may be displayed to the viewers along with progress bar 106. In other examples, only progress bar 106 may be displayed without graph 108. In some examples, graph 108 and progress bar 106 can be hidden.

In one example, the amplitudes of the peaks may be used to compute an average amplitude. The computed average amplitude may be used as threshold line 103. Threshold line 103 may be used to determine that any portions of graph 108 exceeding threshold line 103 are relevant scenes. For example, the media fast-forwarding system may continue to fast-forward until the progression reaches point 116 where graph 108 starts to cross threshold line 103. At point 116, the media fast-forwarding system may automatically disengage fast-forwarding and play the media content at normal speed until reaching point 118 where graph 108 may cross threshold line 103 again. The media fast-forwarding system may automatically re-engage fast-forwarding until reaching point 120 where graph 108 crosses threshold line 103 for the second time. The interval 122 shows an interval between points 116 and 118 and may represent one or more scenes involving major actions and important dialogues among the characters. If the viewer skips these scenes, the viewer may experience trouble grasping the entire storyline of the media content.

Referring to FIG. 1B, when progress bar 106 reaches point 116, the media fast-forwarding system may automatically disengage the fast-forwarding and play the media content at a normal speed until progress bar 106 reaches point 118. Normal play sign 114 may appear on display screen 102. The media fast-forwarding system may override the viewer's fast-forwarding command 124 to play the relevant segments at a normal speed even when the viewer is continuously pressing the fast-forwarding button.

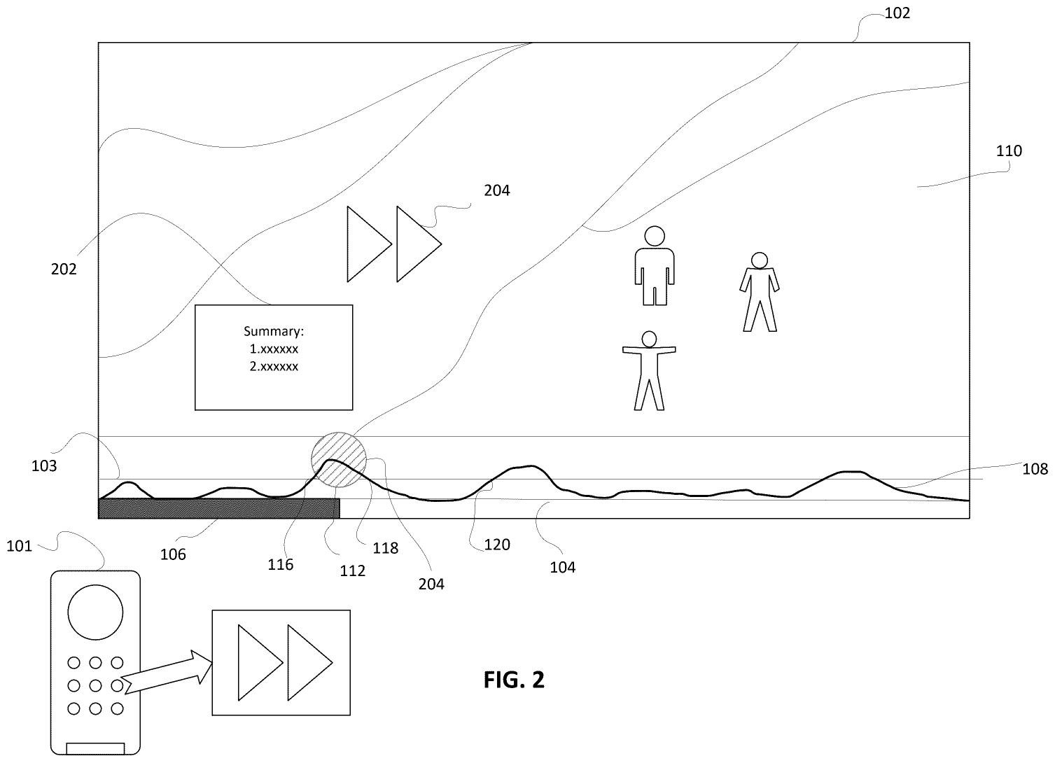

Referring to FIG. 2, the media fast-forwarding system may allow the system to fast-forward the media content until reaching point 116 where graph 108 crosses threshold line 103. However, in this example, the media fast-forward system may forego disengaging the fast-forwarding at point 116 and continue fast-forwarding until reaching point 120. The media fast-forwarding system may generate summary 202 in text format. Summary 202 may contain a summary of the story, context, action, dialogues, etc. taking place in the scenes contained in segment 204. Segment 204 may include one or more scenes and correspond to the playback time of the interval between points 116 and 118. Summary 202 may be displayed on an overlay display on display screen 102 and displayed in a way not to obstruct the view of the viewer. Fast-forwarding sign 204 may appear while summary 202 is being displayed. Summary 202 may be displayed until the progress bar reaches point 120 where graph 108 crosses threshold line 103 for the second time. At point 120, the media fast-forwarding system may generate and display a new summary. According to some examples, the media fast-forwarding system may generate summary 202 to include a summary of the entire portion of the media content fast-forwarded through point 118. In such a case, the more relevant portion of the fast-forwarded scenes corresponding to a segment such as segment 204 may be summarized first and the remaining portion of the media content may be summarized and displayed as auxiliary information.

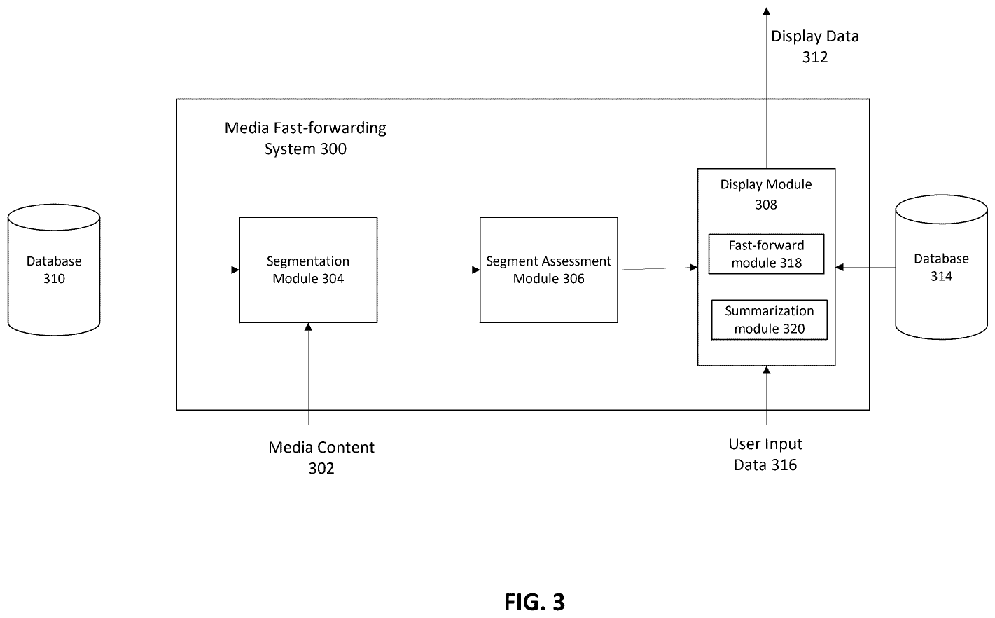

FIG. 3 depicts a block diagram illustrating an example media fast-forwarding system. Media fast-forwarding system 300 may detect a viewer-initiated fast-forwarding of the media content and determine when to stop the fast-forwarding. The media fast-forwarding system may identify relevant scenes and automatically disengage fast-forwarding of the media content immediately before the start point of the relevant scenes. Media fast-forwarding system 300 may include various modules such as segmentation module 304, segment assessment module 306, and display module 308. Media fast-forwarding system 300 may receive media content 302. Media fast-forwarding system 300 may parse media content 302 and divide the media content 302 into one or more segments. Media fast-forwarding system 300 may divide the media content 302 into the one or more segments based on metadata stored in database 310. Metadata may include information related to when camera angles, background music changes, or main characters appear or disappear, etc. Each segment may contain one or more scenes. According to some examples, a machine learning model may be stored in database 310 and trained with segment information of similar media content to divide the media content 302 into the one or more segments. In another example, media fast-forwarding system 300 may divide media content 302 into equal lengths. For example, media content 302 may be divided into segments of five-minute length each.

Segment assessment module 306 may analyze each segment and determine whether each segment contains relevant scenes. Relevant scenes may include scenes central to understanding the storyline of media content 302. In some examples, the relevant scenes may be determined based on the number of replays, views, frequencies of capturing clips, clips downloaded from each scene, or “likes” posted on social media websites. In other examples, the scenes containing a sudden event change in the plot may suggest that those scenes are relevant. According to other examples, relative scenes may contain graphical or textual information/signs appearing in the background or displayed on buildings, etc. Segment assessment module 306 may also determine a threshold value based on the number of likes, views, and replays. Segment assessment module 306 may generate a graph based on the number of replays, views, clips downloaded, etc. The generated graph may contain one or more spikes. The average of the amplitudes of the smallest and the largest spikes or the average of all amplitudes of the spikes may be used to determine a threshold value. A threshold line may be generated based on the threshold value. The generated graph may be used to compare with the threshold line. Any portions of the media content 302 whose position on the generated graph falls under the threshold line may be considered irrelevant and skipped.

Display module 308 may include fast-forward module 318 and summarization module 320. Display module 308 may receive user input data 316. User input data 316 may indicate that a viewer has just pressed a fast-forwarding button on a remote controller or any type of graphical user interface on a display screen. Fast-forward module 318 may determine when to disengage fast-forwarding. Fast-forward module 318 may disengage the fast-forwarding when the progression of the fast-forward media content reaches a point where a segment containing relevant scenes begins. Fast-forward module 318 may disengage the fast-forwarding and playback the media content at a normal speed until the progression of the media content reaches the point where the segment containing the relevant scenes ends. Fast-forward module 318 may automatically re-engage the fast-forwarding until the progression reaches the start point of the next segment containing the relevant scenes.

Display module 308 may forgo disengaging the fast-forwarding when summarization module 320 can retrieve the summary information of the fast-forwarding (i.e. skipped) segments. The summary information can be retrieved from database 314. Summarization module 320 may output the summary information as display data 312 and media fast-forwarding system 300 may display the summary information in the text format on the display screen without disengaging the fast forwarding. The summary information may appear on the display screen when the segment containing the relevant scenes starts and disappear when the segment ends. Display data 312 may include a displayed sign indicating the manual fast-forwarding is being disengaged.

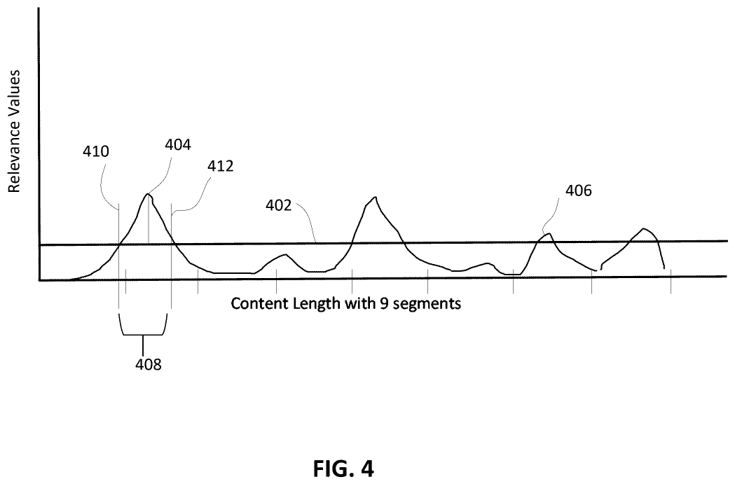

FIG. 4 depicts a graph illustrating one or more spikes based on relevancy values and a threshold line. Peak 404 may indicate a scene where the greatest number of viewers have viewed, replayed, or posted positive reactions. Media fast-forwarding system may divide the media content in this example into nine (9) segments in equal length. Graph 406 may be generated based on the number of views, replays, and likes for each scene. Interval 408 may be determined based on the starting point 410 and endpoint 412. Starting point 410 may be the point where graph 406 crosses threshold line 402. Endpoint 412 may be a point where graph line 406 re-crosses threshold line 402. According to some examples, starting point 410 is the point where the media fast-forwarding system may disengage the fast-forwarding of the media content, and endpoint 412 may be the point where the media fast-forwarding system may re-engage the fast-forwarding of the media content.

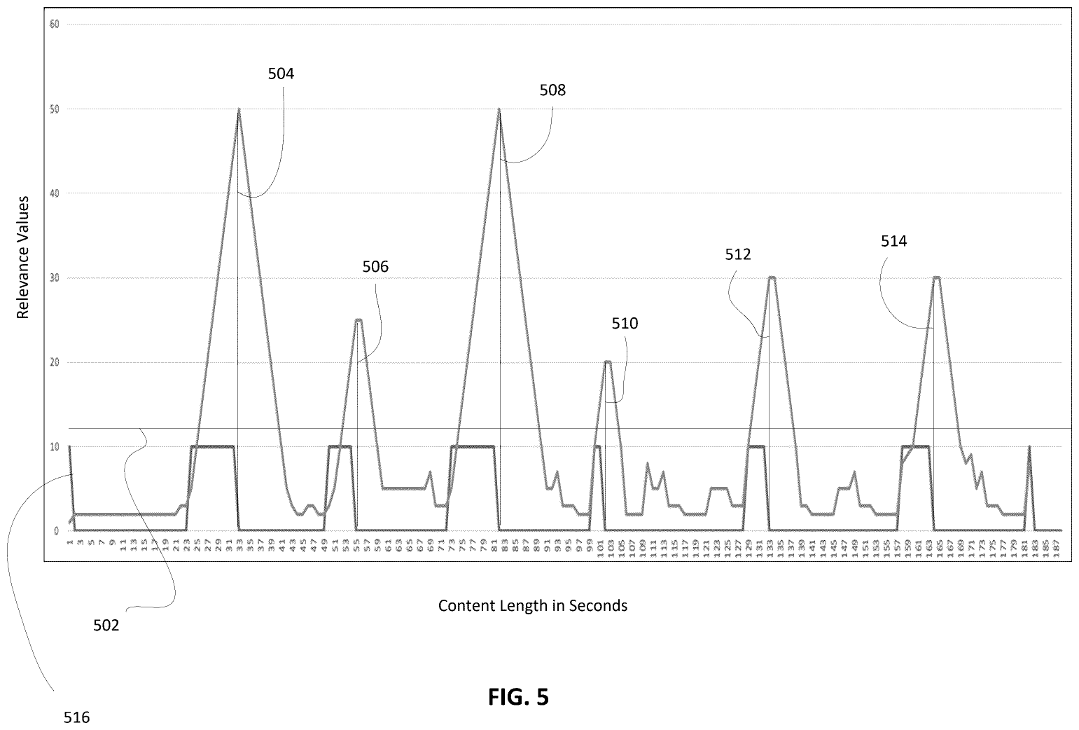

FIG. 5 depicts a graph illustrating amplitudes of one or more spikes that can be used to determine a threshold value. In this example, graph 516 may be plotted based on the relevance values of each scene of the media content. The relevance values may be obtained based on parameters, such as the number of views, replays, positive reactions, etc. Graph 517 may include six (6) peaks. Each peak has a corresponding peak amplitude 504-514, respectively. Peak amplitudes 504-514 may be used to compute an average amplitude. The computed average amplitude may be used to determine threshold line 502.

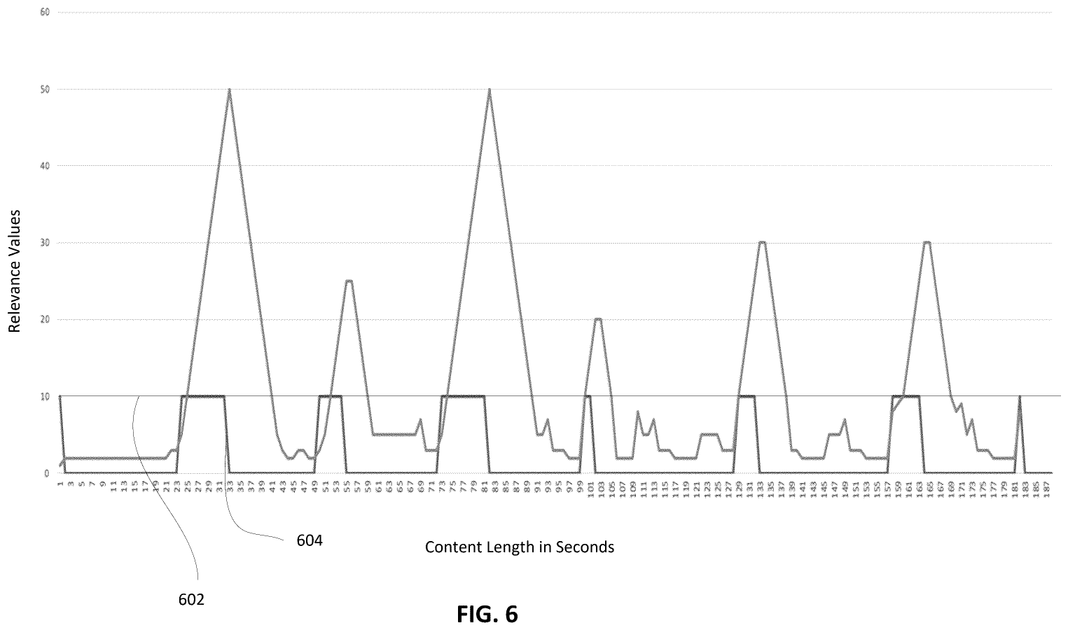

FIG. 6 depicts a threshold value determined based on the differentials obtained from the changes in relevance values. In this example, differential line 604 may be drawn using differentials or change rates in the relevance values of each scene of the media content. Differentials may refer to a mathematical operation that calculates the rate of change of a function (i.e. the line graph 516) with respect to a variable. Differential line 604 may contain the peaks with identical amplitudes since each peak in this example has the same rate of change or slope for illustration purposes only. Threshold line 602 may be determined based on the value of the top peaks of differential line 604.

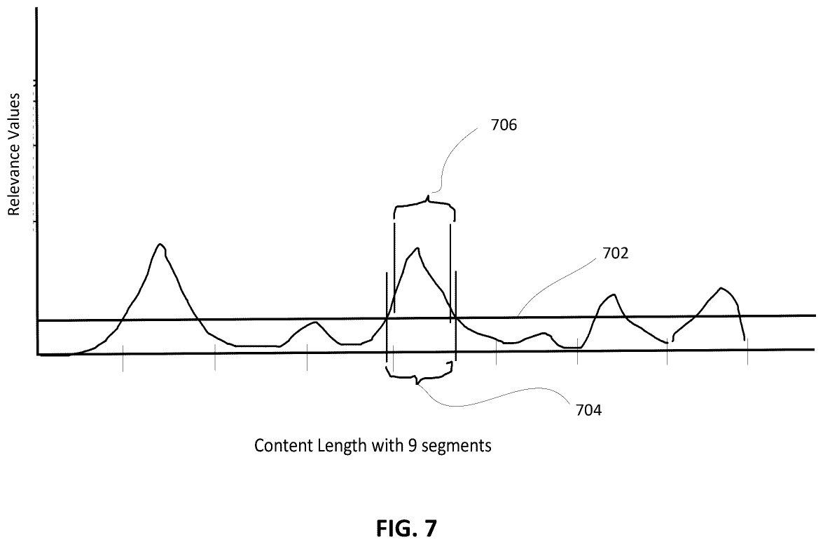

FIG. 7 depicts a graph illustrating a range of the relevant segments adjustable based on a viewer's preference. Interval 704 may be determined by the media fast-forwarding system based on the starting point of the second peak and the endpoint of the second peak. The media fast-forwarding system may either disengage the fast-forwarding and play the portion of the media content corresponding to interval 704 or display a summary of the content of the scenes without disengaging the fast-forwarding of the media content. The start point and endpoint may be determined using threshold line 702. Interval 704 may be adjusted by a viewer's historical data. The media fast-forwarding system may access local storage and retrieve the viewer's historical data as to whether the viewer has a history of overriding the system's automatic disengagement of the fast-forwarding or adjusting the interval of the relevant segment of similar media content in the past. For example, the viewer may have declined to view a fighting scene even if the fighting scene contains relevant information to understand the plot of the media content. The media fast-forwarding system may skip any introductory scene that precedes any major fighting scenes contained in the segment corresponding to interval 704 and playback the reduced segment 706 at a normal speed. The reduced segment 706 may omit any scenes that come before the actual physical contact of the main characters takes place (e.g. dialogues or background music immediately before or after the fight).

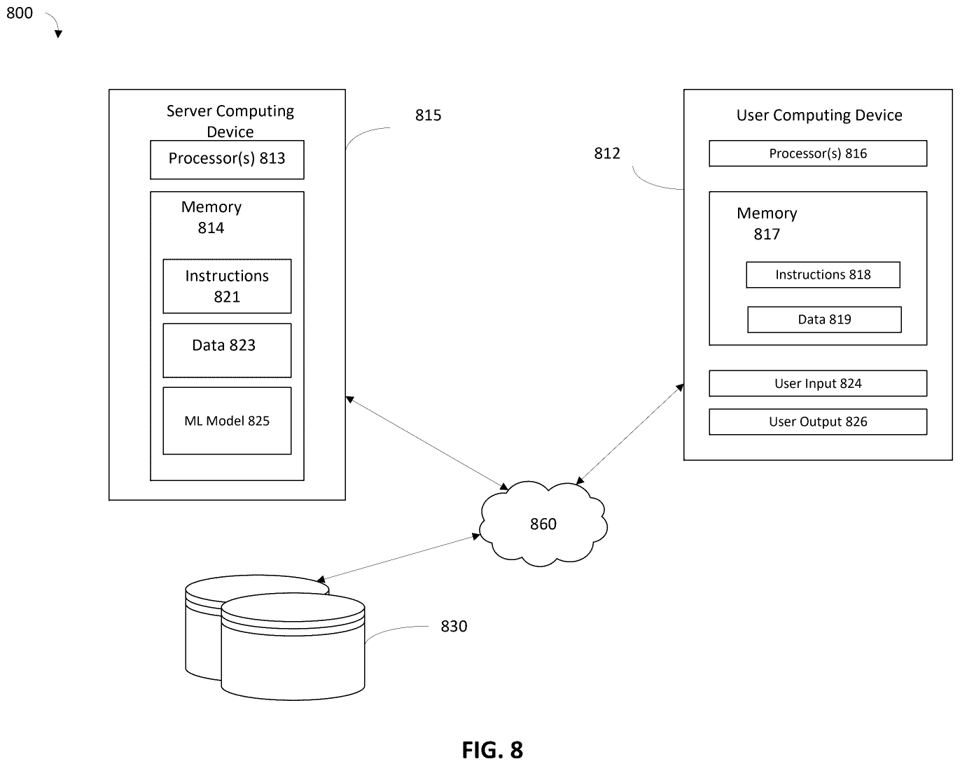

FIG. 8 depicts a block diagram illustrating example components of a media fast-forwarding system. User computing device 812 may include a television, mobile computing device, or other user device with a display that can be adapted to display media content. Server computing device 815 may be a component of media fast-forwarding system 300 illustrated in FIG. 3. Server computing device 815 may provide the media content to the user computing device 812 for display. Server computing device 815 may further provide metadata related to the media content. For example, the metadata includes information as to how the media content can be divided into one or more segments. User computing device 812 may transmit a request from a viewer to server computing device 815 to fast-forward the media content. In response to receiving the request, server computing device 815 may retrieve the summary content or information from storage device 830 as to the portion of the segments where the fast-forwarding should be stopped. The retrieved summary content may be displayed on a display of user computing device 812.

User computing device 812 and the server computing device 815 can be communicatively coupled to one or more storage devices 830 over a network 860. The storage device(s) 830 can be a combination of volatile and non-volatile memory and can be at the same or different physical locations than the computing devices 812, 815. For example, the storage device(s) 830 can include any type of non-transitory computer-readable medium capable of storing information, such as a hard-drive, solid state drive, tape drive, optical storage, memory card, ROM, RAM, DVD, CD-ROM, write-capable, and read-only memories.

The server computing device 815 can include one or more processors 813 and memory 814. Memory 814 can store information accessible by the processor(s) 813, including instructions 821 that can be executed by the processor(s) 813. Memory 814 can also include data 823 that can be retrieved, manipulated, or stored by the processor(s) 813. Memory 814 can further include machine learning model 825. Machine learning model 825 may be trained to identify relevant segments and divide the media content into one or more segments based on the relevancies.

Memory 814 can be a type of non-transitory computer-readable medium capable of storing information accessible by the processor(s) 813, such as volatile and non-volatile memory. The processor(s) 813 can include one or more central processing units (CPUs), graphic processing units (GPUs), field-programmable gate arrays (FPGAs), and/or application-specific integrated circuits (ASICs), such as tensor processing units (TPUs).

Instructions 821 can include one or more instructions that when executed by the processor(s) 813, cause the one or more processors to perform actions defined by the instructions. Instructions 821 can be stored in object code format for direct processing by the processor(s) 813, or in other formats including interpretable scripts or collections of independent source code modules that are interpreted on demand or compiled in advance. Instructions 821 can include instructions for implementing processes consistent with aspects of this disclosure. Such processes can be executed using the processor(s) 813, and/or using other processors remotely located from the server computing device 815.

The data 823 can be retrieved, stored, or modified by the processor(s) 813 in accordance with instructions 821. Data 823 can be stored in computer registers, in a relational or non-relational database as a table having a plurality of different fields and records, or as JSON, YAML, proto, or XML documents. Data 823 can also be formatted in a computer-readable format such as, but not limited to, binary values, ASCII, or Unicode. Moreover, data 823 can include information sufficient to identify relevant information, such as numbers, descriptive text, proprietary codes, pointers, references to data stored in other memories, including other network locations, or information that is used by a function to calculate relevant data.

User computing device 812 can also be configured similar to the server computing device 815, with one or more processors 816, memory 817, instructions 818, and data 819. The user computing device 812 can also include a user output 826, and a user input 824. The user input 824 can include any appropriate mechanism or technique for receiving input from a user, such as a keyboard, mouse, mechanical actuators, soft actuators, touchscreens, microphones, and sensors.

Server computing device 815 can be configured to transmit data to the user computing device 812, and the user computing device 812 can be configured to display at least a portion of the received data on a display implemented as part of the user output 826. The user output 826 can also be used for displaying an interface between the user computing device 812 and the server computing device 815. The user output 826 can alternatively or additionally include one or more speakers, transducers, or other audio outputs, a haptic interface or other tactile feedback that provides non-visual and non-audible information to the platform user of the user computing device 812.

Although FIG. 8 illustrates the processors 813, 816 and the memories 814, 817 as being within the computing devices 815, 812, components described in this specification, including the processors 813, 816 and the memories 814, 817 can include multiple processors and memories that can operate in different physical locations and not within the same computing device. For example, some of the instructions 821, 818 and the data 823, 819 can be stored on a removable SD card and others within a read-only computer chip. Some or all of the instructions and data can be stored in a location physically remote from, yet still accessible by, the processors 813, 816. Similarly, processors 813, 816 can include a collection of processors that can perform concurrent and/or sequential operations. Computing devices 815, 812 can each include one or more internal clocks providing timing information, which can be used for time measurement for operations and programs run by computing devices 815, 812.

The server computing device 815 can be configured to receive requests to process data from the user computing device 812. For example, environment 800 can be part of a computing platform configured to provide a variety of services to users, through various user interfaces and/or APIs exposing the platform services. One or more services may include automatically creating a new version of the media content by reducing the runtime without affecting quality or changing the context of the storyline of the media content.

Devices 812, 815 can be capable of direct and indirect communication over network 860. Devices 812, 815 can set up listening sockets that may accept an initiating connection for sending and receiving information. The network 860 itself can include various configurations and protocols including the Internet, World Wide Web, intranets, virtual private networks, wide area networks, local networks, and private networks using communication protocols proprietary to one or more companies. Network 860 can support a variety of short- and long-range connections. The network 860, in addition, or alternatively, can also support wired connections between devices 812, 815, including over various types of Ethernet connection.

Although a single server computing device 815 and user computing device 812 are shown in FIG. 8, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

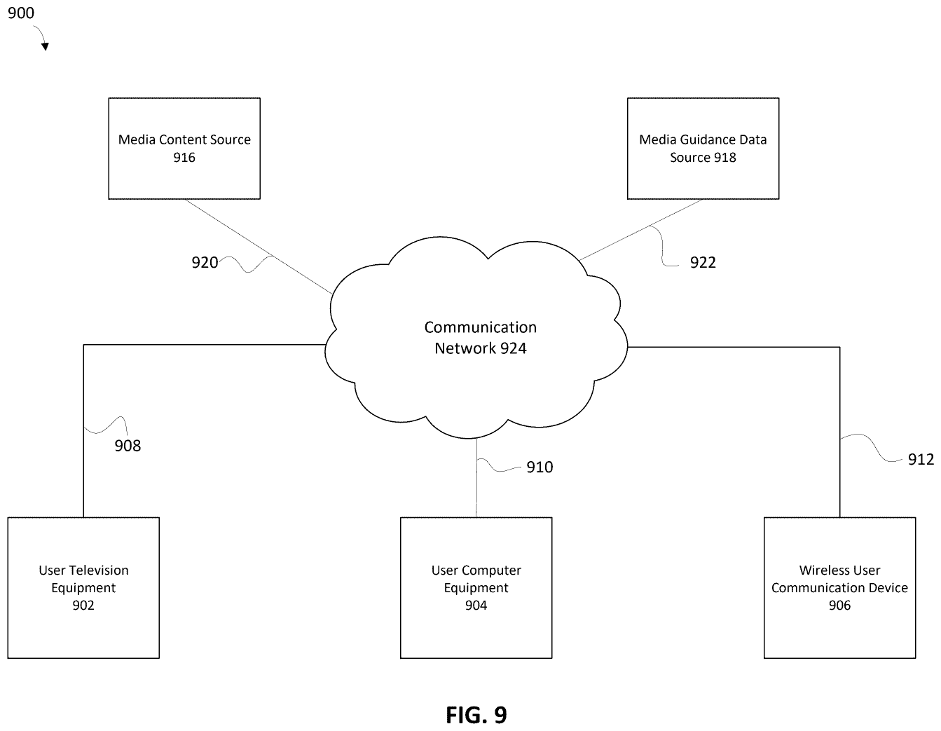

FIG. 9 depicts a block diagram illustrating an example media system 900. Media system 900 may include user television equipment 902, user computer equipment 904, wireless user communication device 906, media content source 916, and media guidance data source 918 are coupled to communication network 924 via paths 908, 910, 912, 920, and 922. User television equipment 902, user computer equipment 904, and wireless user communication device 906 may comprise one or more user computing devices 812 as illustrated in FIG. 8. Media content source 916 and media guidance data 918 may comprise one or more server computing devices 815 as illustrated in FIG. 8. User computer equipment 904 and user television equipment 902 may be Internet-enabled and allow for access to Internet content. User computer equipment 904 may include a tuner allowing for access to television programming. A media guidance application may be tailored to the display capabilities of both user computer equipment 904 and user television equipment 902. For example, on user computer equipment 904, the guidance application may be provided as a website accessed by a web browser. Paths 908, 910, 912, 920, and 922 may include one or more communication paths, such as a satellite path, a fiber-optic path, a cable path, a path that supports internet communication, or any other suitable wired or wireless communication path, or a combination of such paths.

Media content source 916 may include one or more types of content distribution equipment including a television distribution facility, cable system headend, satellite distribution facility, programming source, intermediate distribution facilities and/or server, internet providers, on-demand media server, and other content providers. Media content source 916 may also include cable sources, satellite providers, on-demand providers, Internet providers, over-the-top content providers, or other providers of content. Media guidance data source 918 may provide media guidance data. Media guidance data may include an interactive television program guide that receives program guide data via a data feed. The media guidance data may also include metadata related to dividing the media content into one or more segments.

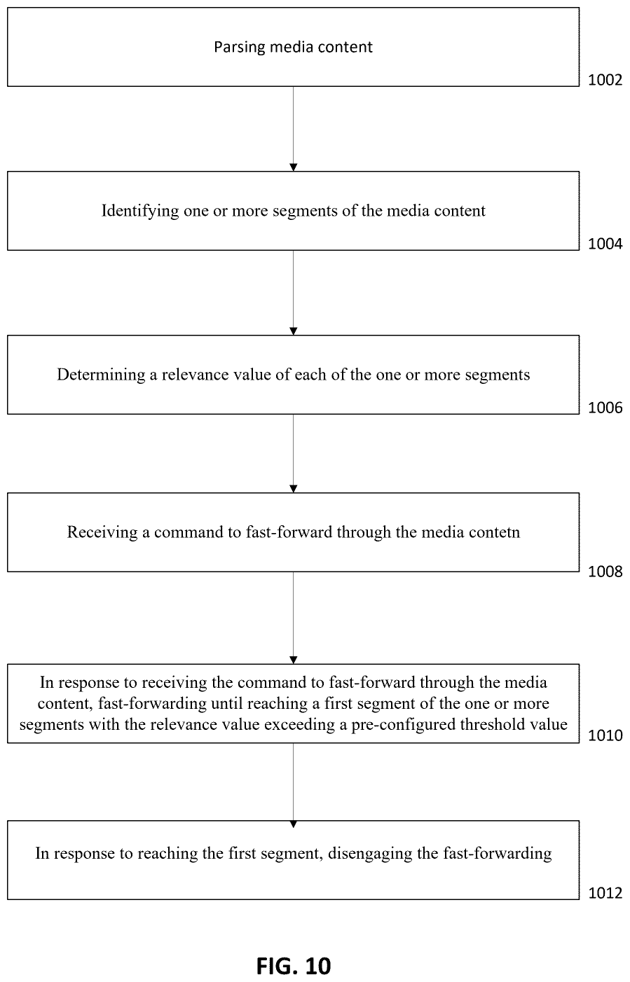

FIG. 10 depicts a flow diagram illustrating an example media fast-forwarding process. According to block 1002, the media fast-forwarding system may parse media content.

According to block 1004, the media fast-forwarding system may identify one or more segments of the media content based on the duration of playback time or relevance values. Each segment may contain multiple scenes. The relevance values of each scene may be determined based on the number of views, replays, and the “likes” posted by the other viewers in the past. The aggregate of the relevance values of the scenes may be considered as a relevance value of a segment.

According to block 1006, the media fast-forwarding system may determine the relevance value of each of the one or more segments. Each segment may contain one or more scenes. Each scene may be assigned a relevance score based on the above parameters. If the relevance value is high, the corresponding scene may be flagged as an important scene needed to understand the storyline of the media content.

According to block 1008, the media fast-forwarding system may receive a command to fast-forward through the media content. The media fast-forwarding system may detect the viewer's inputting a commend to fast-forward using a remote controller or graphical user interface on a display screen.

According to block 1010, the media fast-forwarding system may, in response to receiving the command to fast-forward through the media content, fast-forward the media content until the progression reaches the first segment with the relevance value exceeding a pre-configured threshold. The media fast-forwarding system may allow the viewer to fast-forward through certain segments and disengage fast-forwarding when the progression of the media content reaches the next segment with the relevance value exceeding the threshold. The threshold may be determined based on an average of the relevance values of each segment. In some examples, a graph may be generated based on the relevance values. The generated graph may include peaks with varying amplitudes. A line depicting the threshold may also be generated to visually compare with the generated graph. Any segments whose positions on the graph are located above the threshold may be flagged as relevant segments.

According to block 1012, the media fast-forwarding system may, in response to reaching the first segment, disengage the fast-forwarding of the media content. When the media fast-forwarding system reaches the starting point of the first segment (i.e. the first point where the generated graph crosses the threshold line), the media fast-forwarding system may disengage the fast-forwarding of the media content. The media fast-forwarding system may playback the first segment at a normal speed. The media fast-forwarding system may reengage the fast-forwarding when the playback time of the first segment ends.

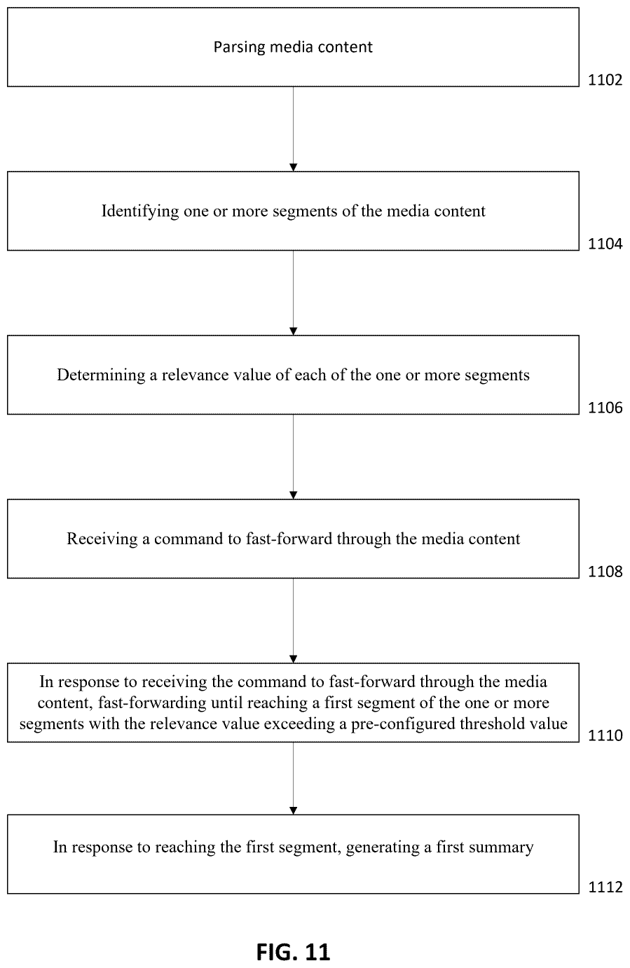

FIG. 11 depicts a flow diagram illustrating an example media fast-forwarding and summary generation process. According to block 1102, the media-fast forwarding system may parse media content.

According to block 1104, the media fast-forwarding system may identify one or more segments of the media content. In some examples, the media fast-forwarding system may use metadata or machine learning models to identify the one or more segments of the media content. Each segment may contain both relevant and irrelevant scenes.

According to block 1106, the media fast-forwarding system may determine the relevance value of each of the one or more scenes within each segment. The aggregate of the relevance values of the scenes may be assigned to each segment as the segment's relevance value. The segment whose relevance value exceeds the threshold may be regarded as a relevant segment and such a segment may be played at a normal speed even when the viewer manually attempts to fast-forward through the segment.

According to block 1108, the media fast-forwarding system may receive the command to fast-forward through the media content. The viewer may attempt to fast-forward through particular segments by continually pressing the fast-forwarding button on a remote controller.

According to block 1110, the media fast-forwarding system may, in response to receiving the command to fast-forward through the media content, fast-forward the media content until reaching the first segment of the one or more segments with the relevance value exceeding a pre-configured threshold value.

According to block 1112, the media fast-forwarding system may in response to reaching the first segment, generate a summary of the important plot or points in the storyline included in the portion of the media content that the viewer is fast-forwarding through. Instead of disengaging the fast-forwarding, the media fast-forwarding system may continue to fast-forward through the relevant segments. The media fast-forwarding system may generate and display a summary of the fast-forwarded relevant segments at the endpoint of such segment.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method for fast-forwarding while preserving a storyline, the method comprising:
parsing a media content;
identifying one or more segments of the media content;
determining a relevance value of each of the one or more segments;
receiving a command to fast-forward through the media content;
in response to receiving the command to fast-forward through the media content, fast-forwarding until reaching a first segment of the one or more segments with the relevance value exceeding a pre-configured threshold value; and
in response to reaching the first segment, taking at least one of a first action or a second action.

2. The method of claim 1, wherein the first action comprises disengaging the fast-forwarding.

3. The method of claim 2, further comprising, reengaging the fast-forwarding until reaching a second segment of the one or more segments with the relevance value exceeding the pre-configured threshold value.

4. The method of claim 2, further comprising:
providing an option to the user to override the disengaging the fast-forwarding.

5. The method of claim 1, wherein the second action comprises generating a first summary of the first segment.

6. The method of claim 5, further comprising displaying the first summary on an overlay display while fast-forwarding.

7. The method of claim 1, wherein the relevance value is determined based on at least one of a historical number of replays, a number of clips generated from each of the one or more segments by previous users, or a number of likes provided by the previous users.

8. The method of claim 1, wherein the relevance value is determined based on texts appearing in each segment of the media content.

9. The method of claim 1, further comprising generating a graph representing one or more spikes indicating most viewed or replayed segments.

10. The method of claim 6, further comprising: determining the pre-configured threshold value based on an amplitude of a smallest spike from the one or more spikes, an average of the amplitude of the smallest and a largest spikes of the one or more spikes or an average of amplitudes of all of the one or more spikes.

11. The method of claim 7, wherein the pre-configured threshold is adjustable based on user's preference data.

12. The method of claim 11, wherein the user preference data includes the user's viewing habits, content preferences and time spent on preferred media contents.

13. A system for fast-forwarding while preserving a storyline, the system comprising:
memory; and
one or more processors configured to:
parse a media content;
identify one or more segments of the media content;
determine a relevance value of each of the one or more segments;
receive a command to fast-forward through the media content;
in response to receiving the command to fast-forward through the media content, fast-forward until reaching a first segment of the one or more segments with the relevance value exceeding a pre-configured threshold value; and
in response to reaching the first segment, take at least one of a first action or a second action.

14. The system of claim 13, wherein the first action comprises disengaging the fast-forwarding.

15. The system of claim 14, wherein the one or more processors are further configured to reengage the fast-forwarding until reaching a second segment of the one or more segments with the relevance value exceeding the pre-configured threshold value.

16. The system of claim 14, wherein the one or more processors are further configured to provide an option to the user to override the disengaging the fast-forwarding.

17. The system of claim 13, wherein the second action comprises generating a first summary of the first segment.

18. The system of claim 17, wherein the one or more processors are further configured to display the first summary on an overlay display while fast-forwarding.

19. The system of claim 13, wherein the relevance value is determined based on at least one of a historical number of replays, a number of clips generated from each of the one or more segments by previous users, or a number of likes provided by the previous users.

20. A non-transitory computer-readable medium storing instructions executable by one or more processors to perform a method for fast-forwarding while preserving a storyline, the method comprising:
parsing a media content;
identifying one or more segments of the media content;
determining a relevance value of each of the one or more segments;
receiving a command to fast-forward through the media content;
in response to receiving the command to fast-forward through the media content, fast-forwarding until reaching a first segment of the one or more segments with the relevance value exceeding a pre-configured threshold value; and
in response to reaching the first segment, taking at least one of a first action or a second action.
